(19) United States
(12) Patent Application Publication
(10) Pub. No.: US 2011/0279312 A1
(43) Pub. Date: Nov. 17, 2011

(54) Generating Accurate Time Assistance Data for An LTE Network

(75) Inventor: Martin Wyville Thomson, Keiraville (AU)

(73) Assignee: ANDREW LLC, Hickory, NC (US)

(21) Appl. No.: 12/780,496

(22) Filed: May 14, 2010

(51) Int. Cl. G01S 19/10

(52) U.S. Cl. 342/357.47

(57) ABSTRACT

A system method for estimating Global Navigation Satellite System assistance data in a communications network. The method may comprise transmitting a location request from a mobility management entity to a location server, requesting a wireless device to transmit a first signal, and transmitting the first signal by the wireless device. A path delay estimate between the wireless device and location server may be determined as a function of an elapsed time for the request to the wireless to be received and as a function of an elapsed time for the transmitted first signal to be received. Satellite assistance data may then be determined as a function of current network time and the determined path delay estimate.

### BACKGROUND

The location of a mobile, wireless or wired device is a useful and sometimes necessary part of many services. The precise methods used to determine location are generally dependent upon the type of access network and the information that can be obtained from the device. For example, in wireless networks, a range of technologies may be applied for location determination, the most basic of which uses the location of the radio transmitter as an approximation.

Exemplary wireless networks may support location services and positioning. Positioning generally refers to a functionality that determines a geographical location of a target UE. Location services generally refer to any services based on or related to location information, which may include any information related to the location of a UE, e.g., measurements, a location estimate, etc. The wireless network may implement a control plane solution or a user plane solution to support location services and positioning. In a control plane solution, messages supporting location services and positioning may be carried as part of signaling transferred between various network entities, typically with network-specific protocols, interfaces, and signaling messages. In a user plane solution, messages supporting location services and positioning may be carried as part of data transferred between various network entities, typically with standard data protocols such as Transmission Control Protocol (“TCP”) and Internet Protocol (“IP”).

One exemplary wireless network is a Long Term Evolution (“LTE”) network. LTE is generally a 4G wireless technology and is considered the next in line in the Global System for mobile Communication (“GSM”) evolution path after Universal Mobile Telecommunications System (“UMTS”)/High Speed Downlink Packet Access (“HSDPA”) 3G technologies. LTE builds on the 3GPP family including GSM, General Packet Radio Service (“GPRS”), Enhanced Data rates for GSM Evolution (“EDGE”), Wideband Code Division Multiple Access (“WCDMA”), High Speed Packet Access (“HSPA”), etc., and is an all-IP standard similar to Worldwide Interoperability for Microwave Access (“WiMAX”). LTE is based on orthogonal frequency division multiplexing (“OFDM”) Radio Access technology and multiple input multiple output (“MIMO”) antenna technology. LTE provides higher data transmission rates while efficiently utilizing the spectrum thereby supporting a multitude of subscribers than is possible with pre-4G spectral frequencies. LTE is all-IP permitting applications such as real time voice, video, gaming, social networking and location-based services. LTE networks may also co-operate with circuit-switched legacy networks and result in a seamless network environment and signals may be exchanged between traditional networks, the new 4G network, and the Internet seamlessly.

A number of applications currently exist within conventional communication systems, such as those supporting GSM, Time Division Multiple Access (“TDMA”), Code Division Multiple Access (“CDMA”), Orthogonal Frequency Division Multiple Access (“OFDMA”) and Universal Mobile Telecommunications System (“UMTS”) technologies, for which location solutions are needed by mobile units, mobile stations, or other devices and by other entities in a wireless network. Examples of such applications may include, but are not limited to, GSM positioning and assisted global navigation satellite system (“A-GNSS”) (e.g., assisted global position system (“A-GPS”)) positioning. A-GNSS adaptable devices may acquire and measure signals from a number of satellites to obtain an accurate estimate of the device's current geographic position. GNSS-based solutions may offer excellent accuracy, but GNSS-based solutions generally suffer from yield issues in indoor environments or in environments that provide a poor line of sight to the open sky in which to best receive GNSS satellite transmissions. Furthermore, embedding GNSS chipsets into devices may also add an associated cost to the manufacturing of the device and an associated cost to A-GNSS functionality in the respective communications network. Further, some organizations are hesitant to offer a positioning method solely based upon the availability of a satellite network controlled by the United States government.

Additionally, accurate timing is a fundamental part of GNSS positioning. For A-GNSS, the reference time assistance data type may provide a GNSS receiver with a time estimate that allows it to more efficiently measure satellites and calculate an accurate time. Reference time assistance data may be generated by an A-GNSS server, which, for example, in an Evolved UMTS Terrestrial Radio Access Network (“E-UTRAN”), is an Evolved Serving Mobile Location Center (“E-SMLC”). This information may be propagated through the network to the GNSS receiver (e.g., the user equipment (“UE”)). Unfortunately, there is a delay between the time that the information is generated and the time that the information is acted on as the message traverses the network.

Currently, for other A-GNSS products, e.g., Secure User Plane Location (“SUPL”) Location Platform (“SLP”), SMLC or Stand Alone SMLC (“SAS”), the A-GNSS server generally compensates for this delay in one of two ways. One conventional method relies upon a configuration that estimates the path delay between server and receiver. This estimated delay (e.g., 1 second) may be added to the current time on the server before calculating and sending the reference time. Another conventional method relies upon knowledge of the timing of the serving radio network in relation to GNSS time. By transmitting information regarding the difference between these two timings, the GNSS receiver may adjust time accordingly. This second conventional method, however, requires that accurate readings regarding the relationship between the two timing systems are made on a per-serving cell basis thereby requiring significant additional configuration and signaling.

There is, however, a need in the art to overcome the limitations of the prior art and provide a novel system and method for locating LTE subscriber stations. There is also a need in the art to provide a novel system and method for generating accurate timing assistance for an LTE network. While supporting LTE protocols are being defined in the 3GPP standards as the next generation mobile broadband technology (e.g., LTE positioning protocol (“LPP”), there is also a need for mobile subscriber or UE location in LTE networks for compliance with the FCC E-911 requirements and for other location based services.

One embodiment of the present subject matter provides a method for estimating GNSS assistance data in a communications network. The method may include transmitting a location request from a mobility management entity (“MME”) to a location server, requesting a wireless device to transmit a first signal, and transmitting the first signal by the wireless device. A path delay estimate between the wireless device and location server may be determined as a function of an elapsed time for the request to the wireless device to be received and as a function of an elapsed time for the transmitted first signal to be received. Satellite assistance data may then be determined as a function of current network time and the determined path delay estimate.

A further embodiment of the present subject matter provides a method for estimating a location of a wireless device in a communications network. The method may include transmitting a location request from the wireless device to a server. A path delay estimate between the server and the wireless device may be determined as a function of a redundant request transmitted by the server to the wireless device or as a function of messages provided in an acknowledgement sub-layer. Satellite assistance data may then be determined as a function of current network time and the determined path delay estimate. This satellite assistance data may be employed to measure signals from one or more GNSS satellites, and a location of the wireless device determined as a function of the measured signals.

Another embodiment of the present subject matter may provide a method for estimating a location of a wireless device in a communications network. The method may comprise transmitting a location request from the wireless device to a server. A path delay estimate between the server and the wireless device may be determined as a function of a default value or as a function of a path delay estimate previously determined for a node serving the wireless device. Satellite assistance data may then be determined as a function of current network time and the determined path delay estimate. This satellite assistance data may be employed to measure signals from one or more GNSS satellites, and a location of the wireless device determined as a function of the measured signals.

These embodiments and many other objects and advantages thereof will be readily apparent to one skilled in the art to which the invention pertains from a perusal of the claims, the appended drawings, and the following detailed description of the embodiments.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments.

FIG. 1 is an illustration of a prior art gateway function.

FIG. 2A is an illustration of an exemplary architectural diagram for CoPL.

FIG. 2B is an illustration of the operation of an exemplary CoPL architecture.

FIG. 3A is an illustration of an exemplary architectural diagram for SUPL.

FIG. 3B is an illustration of the operation of an exemplary SUPL architecture.

FIG. 4 is a simplified sequence diagram of a standard A-GPS positioning procedure for an LTE Network.

FIG. 5 is a diagram of one embodiment of the present subject matter.

FIG. 6 is a diagram of another embodiment of the present subject matter.

FIG. 7 is a diagram of a further embodiment of the present subject matter.

### DETAILED DESCRIPTION

With reference to the figures where like elements have been given like numerical designations to facilitate an understanding of the present subject matter, the various embodiments of a system and method for generating accurate timing assistance for an LTE network are herein described.

As mobile networks transition towards 3G and beyond, location services (LCS, applications of which are sometimes referred to as Location Based Services, or LBS) have emerged as a vital service component enabled or provided by wireless communications networks. In addition to providing services conforming to government regulations such as wireless E911, LCS solutions also provide enhanced usability for mobile subscribers and revenue opportunities for network operators and service providers alike. The phrases subscriber station, mobile station, mobile appliance, wireless device, and user equipment (“UE”) are used interchangeably throughout this document and such should not limit the scope of the claims appended herewith. Further, the terms station and device are also used interchangeably throughout this document and such should not limit the scope of the claims appended herewith.

Position includes geographic coordinates, relative position, and derivatives such as velocity and acceleration. Although the term “position” is sometimes used to denote geographical position of an end-user while “location” is used to refer to the location within the network structure, these terms may often be used interchangeably without causing confusion. Common position measurement types used in mobile positioning or LCS include, but are not limited to, range, proximity, signal strength (such as path loss models or signal strength maps), round trip time, time of arrival, and angle of arrival. Multiple measurements can be combined, sometimes depending on which measurement types are available, to measure position. These combination approaches include, but are not limited to, radial (for example, employing multiple range measurements to solve for best agreement among circular loci), angle (for example, combining range and bearing using signal strength or round trip time), hyperbolic (for example, using multiple time-of-arrival), and real time differencing (for example, determining actual clock offsets between base stations).

Generally, LCS methods are accomplished through Control Plant (“CoP”) or User Plane (“UP”) methods. CoP Location (“CoPL”) refers to using the control signaling channel within the network to provide location information of the subscriber or UE. UP Location (“UPL”), such as Secure User Plane Location (“SUPL”) uses the user data channel to provide location information. CoPL location approaches include, but are not limited to, Angle-of-Arrival (“AOA”), Observed Time-Difference-of-Arrival (“OTDOA”), Observed-Time-Difference (“OTD”), Enhanced-OTD (“E-OTD”), Enhanced Cell-ID (“E-CID”), A-GPS, and A-GNSS. UPL approaches include, but are not limited to, A-GPS, A-GNSS, and E-CID, where this position data is communicated over IP.

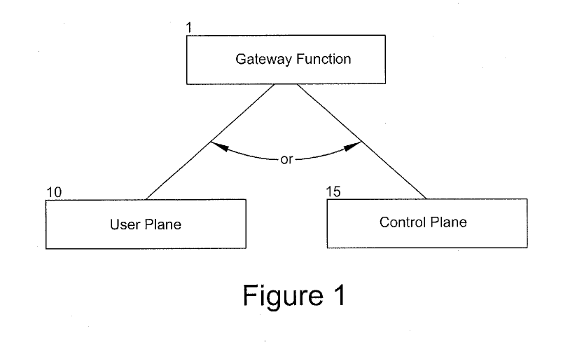

There are two established architectures associated with location determination in modern cellular networks. The architectures are CoP and UP architectures. Typically location requests are sent to a network through a query gateway function 1. Depending on the network implementation CoP 15 or UP 10 may be used but not a combination of both, as shown in FIG. 1. Note that queries may also come directly from the target device itself rather than via a gateway. Similarly, CoP or UP may be used but not both.

The difference between user plane and control plane, generally, is that the former uses the communication bearer established with the device in order to communicate measurements. The latter uses the native signaling channels supported by the controlling network elements of the core and access to communicate measurements. As such, a CoPL solution supporting A-GPS would use its control plane signaling interfaces to communicate GPS data to/from the handset. Similarly UPL can conduct E-OTD, i.e., the handset takes the timing measurements but it communicates them to the location platform using the data bearer. UPL has the advantage of not depending on specific access technology to communicate measurement information. CoPL has the advantage that it can access and communicate measurements which may not be available to the device. Current models generally require network operators to deploy one or the other, CoPL or UPL.

CoPL generally uses the native signaling plane of the network to establish sessions and communicate messages associated with location requests and to communicate measurements used for determining location. The control plane is the signaling infrastructure used for procedures such as call control, hand-off, registration, and authentication in a mobile network; CoPL uses this same infrastructure for performing location procedures. CoPL can utilize measurements made by both the control plane network elements as well as the end-user device being located.

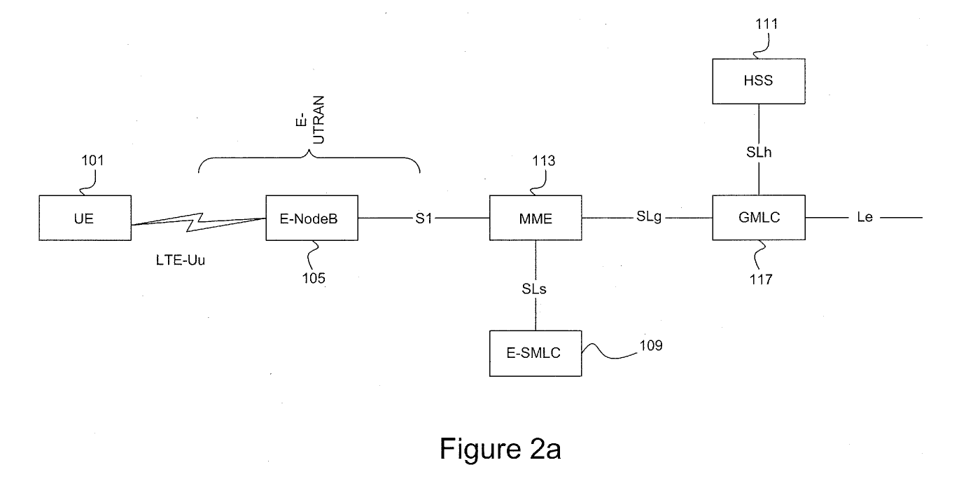

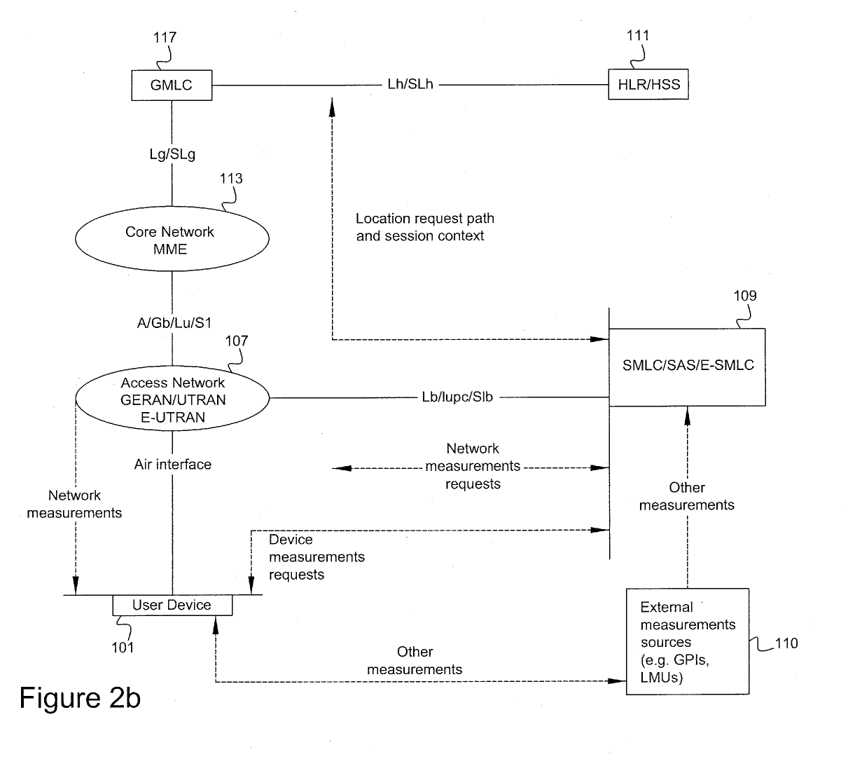

FIG. 2A illustrates an exemplary architectural diagram of CoPL. A mobile station or mobile appliance 101 communication with an E-NodeB 105 via wireless interface LTE-Uu. A mobility management entity (“MME”) 113 coordinates between the mobile appliance communication network and a gateway mobile location center (“GMLC”) 117. In operation, a location measurement device (not shown) may be connected to the E-NodeB 105 and make measurements on the RF signals of the LTE-Uu interface, along with other measurements to support one or more of the position methods associated with the CoPL. Measurements from the location measurement units are sent to a serving mobile location center (“SMLC”) or Evolved-SMLC (“E-SMLC”) 109 where the location of a mobile appliance/UE 101 can be determined. The GMLC 117 may be connected to a home subscriber server (“HSS”) 111 over an SLh interface.

The operation of a CoPL architecture is shown in FIG. 2B. This shows the 3GPP location services architecture. A gateway mobile location centre (“GMLC”) 117 is the network element that receives the location requests. The GMLC queries the HLR/HSS 111 over the Lh/SLh interface to find out which part of the access network 107 is currently serving the target device. The GMLC 117 sends a location request to the current serving core network node 113 via the Lg/SLg interface. The current serving core network node 113 (e.g., MME) then passes the request to the part of the access network 107 attached to the target device (e.g., GERAN BSC, UTRAN RNC or E-UTRAN RNC). This access network element 107 then invokes the facilities of the SMLC/SAS/E-SMLC 109. The location request session between the access network node 107 and the SMLC/SAS/E-SMLC 109 provides a channel by which the SMLC/SAS/E-SMLC 109 can ask for network measurements or to send messages to the end-user device 101 so that device measurement information can be exchanged. The SMLC/SAS/E-SMLC 109 may also obtain location measurement information from external devices 110 such as location measurement units (“LMUs”) which take RF readings from the air interface. Similarly, the device may also take measurements from external systems, such as GPS satellites, and communicate these to the SMLC/SAS/E-SMLC 109.

The Evolved SMLC (“E-SMLC”) is generally a new serving location node defined by 3GPP and is analogous to the GERAN-SMLC and UTRAN-SAS. The E-SMLC hosts the position calculation functions and is responsible for the overall coordination of a location request including selecting appropriate positioning technologies based on the requested quality of service (accuracy, response time), interacting with the mobile appliance and access network to serve assistance data and obtain appliance and network based measurements, providing the position calculation function, fallback positioning in case the primary location technique of choice fails, and generally assuring that a location result is provided back to the tasking entity. Thus, the E-SMLC may generally support the interface to the MME in accordance with 3GPP protocol specifications, support multiple positioning technologies including Cell ID, E-CID, handset-based and handset-assisted A-GPS/A-GNSS, OTDOA, uplink timing LMU technology, AOA, and hybrid positioning in accordance with emerging standards and the demands of the market.

Developed as an alternative to CoPL, SUPL is generally a set of standards managed by the Open Mobile Alliance (“OMA”) to transfer assistance data and positioning data over IP to aid network and terminal-based positioning technologies in ascertaining the position of a SUPL Enabled Terminal (“SET”). UPL does not explicitly utilize the control plane infrastructure. Instead UPL assumes that a data bearer plane is available between the location platform and the end-user device. That is, a control plane infrastructure may have been involved in establishing the data bearer so that communication can occur with the device but no location-specific procedural signaling occurs over the control plane. As such, UPL is limited to obtaining measurements directly from the end-user device itself.

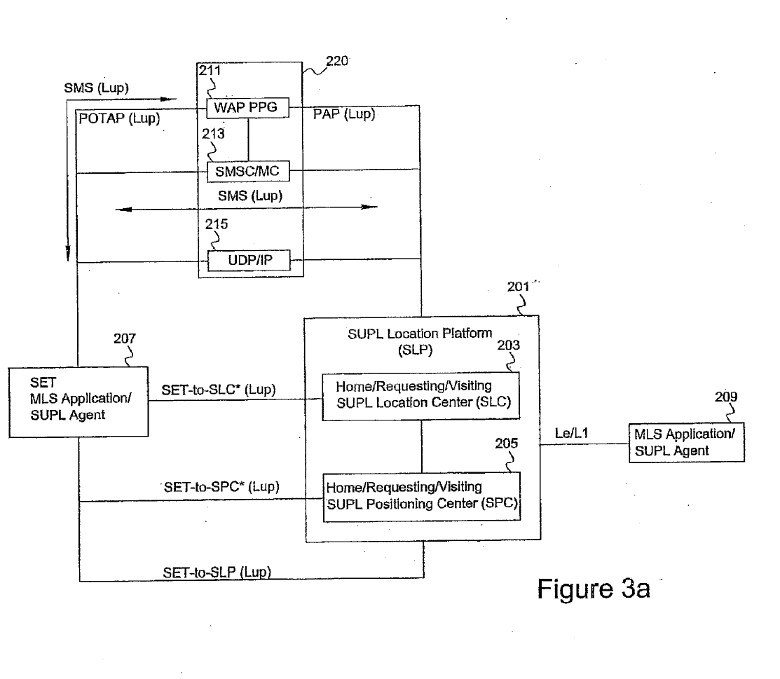

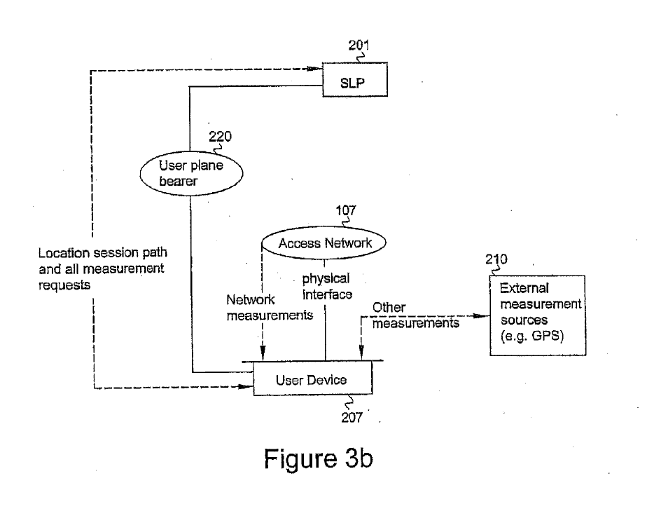

SUPL includes a Lup reference point, the interface between the SUPL Location Platform (“SLP”) and SET, as well as security, authentication, authorization, charging functions, roaming, and privacy functions. For determining position, SUPL generally implements A-GPS, A-GNSS, or similar technology to communicate location data to a designated network node over IP. FIG. 3A illustrates an exemplary architectural diagram for SUPL. The illustrated entities represent a group of functions, and not necessarily separate physical devices. In the SUPL architecture, an SLP 201 and SET 207 are provided. The SLP 201 may include a SUPL Location Center (“SLC”) 203 and a SUPL Positioning Center (“SPC”) 205. The SLC and SPC optionally communicate over the LIp interface, for instance, when the SLC and SPC are deployed as separate entities. The SET 207 generally includes a mobile location services (“MLS”) application, an application which requests and consumes location information, or a SUPL Agent, a service access point which accesses the network resources to obtain location information.

For any SET, an SLP 201 can perform the role of the home SLP (“H-SLP”), visited SLP (“V-SLP”) or emergency SLP (“E-SLP”). An H-SLP for a SET includes the subscription, authentication, and privacy related data for the SET and is generally associated with a part of the SET's home public land mobile network (“PLMN”). A V-SLP for a SET is an SLP selected by an H-SLP or E-SLP to assist in positioning thereof and is associated with or contained in the PLMN serving the SET. The E-SLP may perform positioning in association with emergency services initiated by the SET. The SLC 203 coordinates operations of SUPL in the network and interacts with the SET over the User Plane bearer to perform various functions including, but not limited to, privacy, initiation, security, roaming, charging, service management, and positioning calculation. The SPC 205 supports various functions including, but not limited to, security, assistance delivery, reference retrieval, and positioning calculation.

SUPL session initiation is network-initiated or SET-initiated. The SUPL architecture provides various alternatives for initiating and facilitating SUPL functions. For example, a SUPL Initiation Function (“SIF”) is optionally initiated using a Wireless Application Protocol Push Proxy Gateway (“WAP PPG”) 211, a Short Message Service Center (“SMSC/MC”) 213, or a User Datagram Protocol/Internet Protocol (“UDP/IP”) 215 core, which forms user plane bearer 220.

The operation of UPL is shown in FIG. 3B. Secure User Plane Location is a standard specification for UPL. Location requests come to the SLP 201 from external applications or from the end-user device itself. If a data session does not exist between the SLP 201 and the device 207 already, then the SLP 201 may initiate a request such that an IP session (user plane bearer 220) is established between the device 207 and the SLP 201. From then on, the SLP 201 may request measurement information from the device 207. The device may also take measurements from the network 107 or from external systems such as GPS 210. Because there is no control plane connectivity to the network, the SLP 201 cannot directly request any measurement information from the network 107 itself. More information on SUPL, including the Secure User Plane Location Architecture documentation (OMA-AD-SUPL), can be readily obtained through OMA.

As discussed above, LTE is generally directed toward a packet-optimized IP centric framework and is expected that voice calls will be transported through IP (e.g., VoIP) and location requests, e.g., E-911, etc., will also be serviced through the same or different IP. One non-limiting, supporting protocol for an exemplary LTE network, LTE Positioning Protocol (“LPP”), is currently in development and may be used by an exemplary node, e.g., E-SMLC, to communicate with a device or UE. LPP may be employed to retrieve UE capabilities, deliver assistance data, request measurement information, and/or to retrieve updated serving cell information.

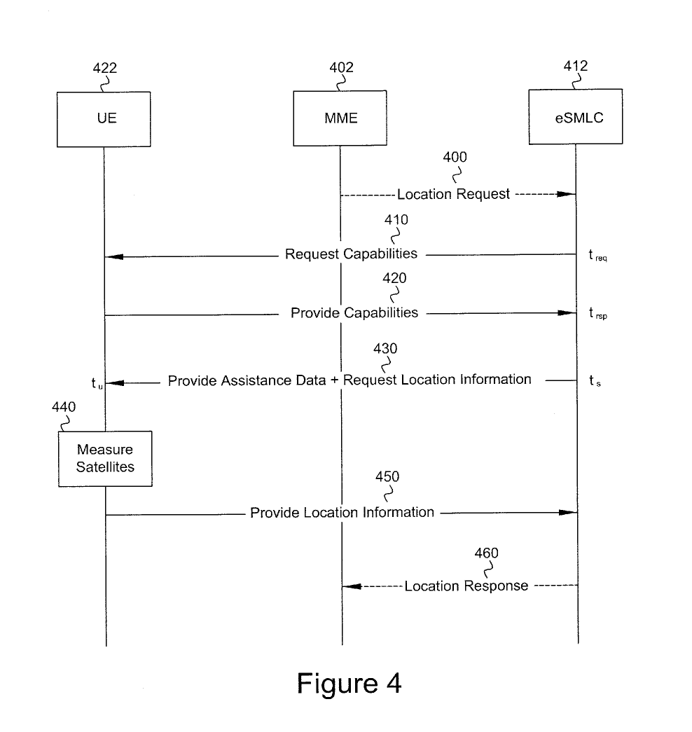

FIG. 4 is a simplified sequence diagram of a standard A-GPS positioning procedure for an LTE Network. With reference to FIG. 4, a location request 410 may be transmitted from an MME 402 to a server, such as but not limited to an E-SMLC 412 or SMLC. Data may also be passed through the MME 402 thereby using the MME 402 as a proxy server, Of course, the MME 402 may provide additional functionality as a control-node for an LTE network. Generally, the MME 402 may be responsible for idle mode UE 422 tracking and paging procedure including retransmissions as well as bearer activation/deactivation process among other functions. For example, the MME 402 may verify authorization of the UE 422 to camp on a service provider's Public Land Mobile Network (“PLMN”), may enforce UE 422 roaming restrictions, provide control plane function for mobility between LTE and 2G/3G access networks, etc. In response to the location request 400, the E-SMLC 412 may transmit a request for capabilities 410 to the UE 422. The UE 422 may then provide signals 420 having appropriate capability and other information to the E-SMLC 412. Assistance data 430 may then be provided to the UE 422, and the UE 422 may take signal measurements 440 of corresponding GNSS satellites. Location information 450 from these satellites may then be transmitted from the UE 422 to the E-SMLC 412 which, in turn, provides a location response 460 to the MME 412. Of course, the preceding exemplary sequence should not limit the scope of the claims appended herewith, as additional information, signals, and nodes have been omitted from FIG. 4 for simplification purposes.

For example, multiple measurements may be employed in embodiments of the present subject matter to perform location determination including, but not limited to, Cell ID, e.g., the nominal area of coverage of the serving cell or cell-sector; E-CID, e.g., with knowledge of the Timing Advance computed by an eNodeB and signal strength measurements of serving and neighbor eNodeBs made by the UE, a location server may refine the location of a UE to an area smaller than the coverage area of a cell/cell sector; OTDOA, e.g., UE reporting of timing measurements of downlink signals from eNodeB to a mobile location center; A-GNSS, e.g., where the satellite systems include GPS, GLONASS, Galileo and other systems and the assistance data will enable a device to quickly lock onto the satellites and obtain and process the pseudorange measurements. Additionally, the network may support an A-GNSS Position Calculation Function (“PCF”) enabling server side processing of the A-GNSS measurements made by the UE and including other network measurements to perform a final location determination of the UE. Further measurements may also include measurements from Wi-Fi networks to determine an initial coarse location for the support of A-GNSS assistance data generation, as fallback to failed A-GNSS position, or as position method in its own right; Uplink Time Difference of Arrival/Multiple Range Estimation Location (U-TDOA/MREL), e.g., utilization of LMUs placed at multiple pre-determined location (typically co-located with the eNodeB) to make timing (or range) measurements of up-link signals from the mobile whereby a location server uses these measurements to triangulate the location of the mobile; AOA, e.g., signals from devices are measured by LMUs at various known points and the position of the mobile determined by triangulation. These location technologies may be supported over both CoPL and SUPL, as applicable.

With continued reference to FIG. 4, the request for capabilities 410 and the response 420 may be used to determine the time that it takes for a message to travel to the UE 422 and the response to return (the round trip time (“RTT”)). RTT may provide an acceptable indication of delays in an exemplary network between the E-SMLC 412 and UE 422. Assuming that the path delay is symmetrical and the UE processes the capabilities request promptly, a path delay estimate may be determined. For example, by dividing the time elapsed between sending the request (t_{req}) and receiving the response (tᵣₛₚ) by two, an estimate of the path delay to the UE 422 may be determined using the following relationship:

path delay (Δtₚ)≈[t_{req}−tᵣₛₚ]/2≈RTT/ (1)

To generate assistance data, the E-SMLC 412 may add the path delay to the current time using the relationship below.

Time at UE (tᵤ)≈Time at E-SMLC (tₛ)+path delay (Δtₚ) (2)

When the UE 422 receives the message 430, the time should be relatively accurate. To account for variations in path delay due to packet size, small reference time assistance data types may be provided in a separate message to other, larger assistance data types. Further, if a packet acknowledgement sub-layer is added to LPP, messages provided by the E-SMLC 412 or UE 422 may be acknowledged upon receipt, and the respective acknowledgement messages may be utilized to refine the respective estimate of the path delay.

While not shown, a location request may, in another embodiment, be initiated from the UE 422 which may then be provided to the server, e.g., E-SMLC 412 or SMLC. In a UE-initiated procedure, the UE 422 may generally provide an MME 402 or E-SMLC 412 with its capabilities and serving cell information thereby removing the need for the request for capabilities 410 and removing the opportunity to measure path delay. In this event, to estimate the path delay in a mobile-originated scenario, the E-SMLC 412 may generate a redundant request (which could request serving cell information, etc.) or may utilize an acknowledgement sub-layer (triggered by sending assistance data that is small and not particularly time-dependent, such as the ionosphere or UTC model). In yet a further embodiment, in the absence of a measured path delay, a default value therefor may be utilized and/or the E-SMLC 412 may re-use a path delay previously calculated for the current serving cell of the UE 422.

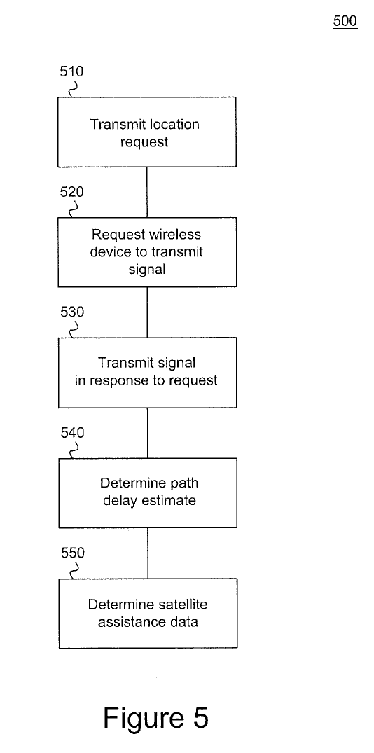

FIG. 5 is a diagram of one embodiment of the present subject matter. With reference to FIG. 5, a method 500 is provided for estimating GNSS assistance data in a communications network. One exemplary network may be, but is not limited to, an LTE network. At step 510, a location request may be transmitted from an MME to a location server (e.g., E-SMLC, etc.), and at step 520 a wireless device may be requested to transmit a first signal. The first signal may include one or more parameters, such as, transport channel parameters, physical channel parameters, Packet data Convergence Protocol parameters, Radio Link Control parameters, physical layer parameters, radio frequency parameters, measurement parameters, Inter-Radio Access Technology parameters, General parameters, Multimedia Broadcast Multicast Service related parameters, and combinations thereof The first signal may also include one or more parameters of GNSS assistance data, those that are not time sensitive, such as but not limited to, satellite ephemeris and clock parameters, ionosphere model, UTC model, differential GPS corrections, other GNSS assistance data, and combinations thereof.

In response to the request, at step 530, the wireless device may transmit the first signal, and a path delay estimate determined between the wireless device and location server as a function of an elapsed time for the request to the wireless device to be received and as a function of an elapsed time for the transmitted first signal to be received at step 540. In one embodiment, the path delay estimate may be determined by the following relationship: (t_{req}−tᵣₛₚ)/2 where t_{req} represents the elapsed time for the request to the wireless device to be received and tᵣₛₚ represents the elapsed time for the transmitted first signal to be received. Step 540 may also include accounting for variations in path delay as a function of packet size.

Satellite assistance data may then be determined as a function of current network time and the determined path delay estimate at step 550. A further embodiment may include the step of refining the path delay estimate as a function of acknowledgement messages transmitted from the server or wireless device. The method 500 may also include the steps of using the satellite assistance data to measure signals from one or more GNSS satellites, and determining a location of the wireless device as a function of the measured signals. Of course, the location of the wireless device may be determined at the wireless device or at the server.

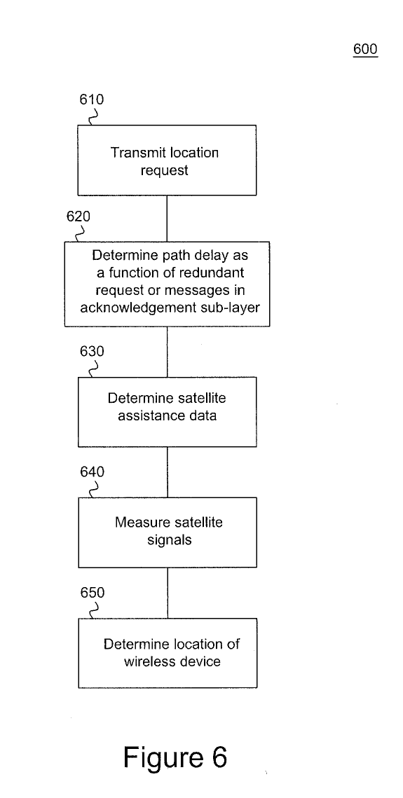

FIG. 6 is a diagram of another embodiment of the present subject matter. With reference to FIG. 6, a method 600 for estimating a location of a wireless device in a communications network is provided. One exemplary network may be, but is not limited to, an LTE network. At step 610, a location request may be transmitted from the wireless device to a server (e.g., E-SMLC, etc.). Of course, the request may be transmitted to the server via an MME. At step 620, a path delay estimate between the server and the wireless device may be determined as a function of a redundant request transmitted by the server to the wireless device or as a function of messages provided in an acknowledgement sub-layer. Satellite assistance data may then be determined at step 630 as a function of current network time and the determined path delay estimate whereby the satellite assistance data may be used to measure signals from one or more GNSS satellites at step 640. A location of the wireless device may then be determined as a function of the measured signals at step 650.

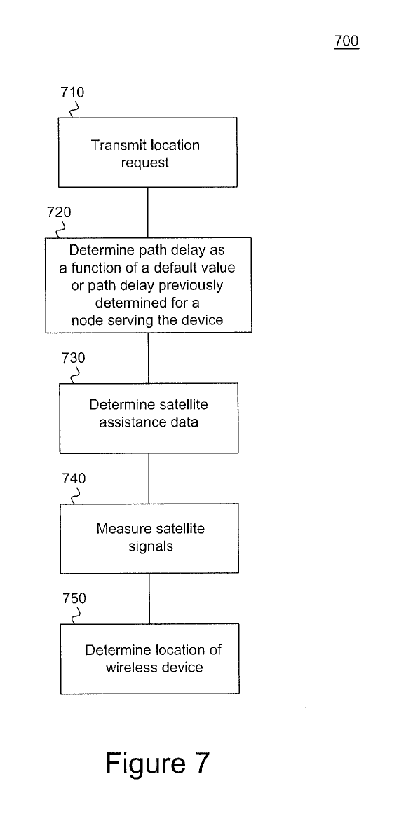

FIG. 7 is a diagram of a further embodiment of the present subject matter. With reference to FIG. 7, a method 700 for estimating a location of a wireless device in a communications network is provided. One exemplary network may be, but is not limited to, an LTE network. At step 710, a location request may be transmitted from the wireless device to a server (e.g., E-SMLC, etc.). Of course, the request may be transmitted to the server via an MME. At step 720, a path delay estimate between the server and the wireless device may be determined as a function of a default value or as a function of a path delay estimate previously determined for a node serving the wireless device. Satellite assistance data may then be determined at step 730 as a function of current network time and the determined path delay estimate whereby the satellite assistance data may be used to measure signals from one or more GNSS satellites at step 740. A location of the wireless device may then be determined as a function of the measured signals at step 750.

As shown by the various configurations and embodiments illustrated in FIGS. 1-7, a system and method for generating time assistance data for an LTE network have been described.

While preferred embodiments of the present subject matter have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. A method for estimating Global Navigation Satellite System (“GNSS”) assistance data in a communications network, the method comprising:
(a) transmitting a location request from a mobility management entity (“MME”) to a location server;
(b) requesting a wireless device to transmit a first signal;
(c) transmitting the first signal by the wireless device;
(d) determining a path delay estimate between the wireless device and location server as a function of an elapsed time for the request to the wireless device to be received and as a function of an elapsed time for the transmitted first signal to be received; and
(e) determining satellite assistance data as a function of current network time and the determined path delay estimate.

2. The method of claim 1 wherein the determined path delay estimate is determined by the following relationship:
(t_{req}−tᵣₛₚ)/2
where t_{req} represents the elapsed time for the request to the wireless device to be received and tᵣₛₚ represents the elapsed time for the transmitted first signal to be received.

3. The method of claim 1 wherein the location server is an evolved serving mobile location center (“E-SMLC”).

4. The method of claim 1 wherein the step of determining a path delay estimate further comprises accounting for variations in path delay as a function of packet size.

5. The method of claim 1 further comprising the step of refining the path delay estimate as a function of acknowledgement messages transmitted from the server or wireless device.

6. The method of claim 1 wherein the communications network is a long term evolution (“LTE”) communications network.

7. The method of claim 1 wherein the first signal includes one or more parameters selected from the group consisting of: transport channel parameters, physical channel parameters, Packet data Convergence Protocol parameters, Radio Link Control parameters, physical layer parameters, radio frequency parameters, measurement parameters, Inter-Radio Access Technology parameters, General parameters, Multimedia Broadcast Multicast Service related parameters, and combinations thereof.

8. The method of claim 1 further comprising the steps of:
(i) using the satellite assistance data to measure signals from one or more GNSS satellites;
(ii) determining a location of the wireless device as a function of the measured signals.

9. The method of claim 8 wherein the location of the wireless device is determined at the wireless device.

10. The method of claim 8 wherein the location of the wireless device is determined by the server using satellite measurements provided to the server from the wireless device.

11. The method of claim 1 wherein the first signal includes one or more parameters of GNSS assistance data selected from the group consisting of: satellite ephemeris and clock parameters, ionosphere model, UTC model, differential GPS corrections, other GNSS assistance data, and combinations thereof.

12. A method for estimating a location of a wireless device in a communications network, the method comprising:
(a) transmitting a location request from the wireless device to a server;
(b) determining a path delay estimate between the server and the wireless device as a function of a redundant request transmitted by the server to the wireless device or as a function of messages provided in an acknowledgement sub-layer;
(c) determining satellite assistance data as a function of current network time and the determined path delay estimate;
(d) using the satellite assistance data to measure signals from one or more Global Navigation Satellite System (“GNSS”) satellites; and
(e) determining a location of the wireless device as a function of the measured signals.

13. The method of claim 12 where the server is an evolved serving mobile location center (“E-SMLC”).

14. The method of claim 12 wherein the communications network is a long term evolution (“LTE”) communications network.

15. The method of claim 12 wherein the step of transmitting a location request further comprises transmitting a location request to the server via a mobility management entity (“MME”).

16. A method for estimating a location of a wireless device in a communications network, the method comprising:
(a) transmitting a location request from the wireless device to server;
(b) determining a path delay estimate between the server and the wireless device as a function of a default value or as a function of a path delay estimate previously determined for a node serving the wireless device;
(c) determining satellite assistance data as a function of current network time and the determined path delay estimate;
(d) using the satellite assistance data to measure signals from one or more Global Navigation Satellite System (“GNSS”) satellites; and
(e) determining a location of the wireless device as a function of the measured signals.

17. The method of claim 16 where the server is an evolved serving mobile location center (“E-SMLC”).

18. The method of claim 16 wherein the communications network is a long term evolution (“LTE”) communications network.

19. The method of claim 16 wherein the step of transmitting a location request further comprises transmitting a location request to the server via a mobility management entity (“MME”).
